(19) United States
(12) Patent Application Publication
(10) Pub. No.: US 2014/0188802 A1
(43) Pub. Date: Jul. 3, 2014

(54) PULL AND PASTE

(71) Applicant: APPSENSE LIMITED, Warrington (GB)

(72) Inventors: Paul Keith BRANTON, Rochdale (GB); James TUPPER, Warrington (GB); Richard James SOMERFIELD, San Jose, CA (US)

(73) Assignee: APPSENSE LIMITED, Warrington (GB)

(21) Appl. No.: 13/731,518

(22) Filed: Dec. 31, 2012

(51) Int. Cl. G06F 17/30

(52) U.S. Cl. CPC G06F 17/30215
USPC 707/634

(57) ABSTRACT

Systems and methods are described for providing pull and paste functionalities. A computerized method of pulling and pasting data among computing devices includes determining attributes of a first computing device, transmitting the attributes of the first computing device to a second computing device, receiving a pulling request for copying information from the first computing device to the second computing device, wherein the information resides on the first computing device, automatically processing the pulling request at the first computing device and automatically generating a response to the pulling request, and automatically sending the response to the pulling request back to the second computing device, wherein the response contains the information.

### BACKGROUND

In a typical copy/cut and paste operation, a user first selects a data object (e.g., text, image, file, etc.) at its source location, next copies/cuts the selected data object (e.g., via a menu item or a keyboard command) at the source location, then moves to a destination location and pastes the copied/cut data object. Thus, a copy/cut and paste operation generally requires three steps: Select—Copy/Cut—Paste. When the source location and the destination location are separate devices, a user is normally required to operate at both locations (e.g., first at the source location then at the destination location) to complete a copy/cut and paste operation. When the source and destination devices are remote to each other, the user may be forced to visit both devices, which can be far away from each other, to perform a copy/cut and paste operation. Additional challenges (e.g., access control, security measures, availability uncertainty, etc.) can also arise, especially when the source and destination locations are physically apart (e.g., when both connected to a network but physically far away from each other). Therefore, an improved mechanism for copying/cutting and pasting data objects, especially between two separate devices, is desired. If the user operation can be avoided from one location (e.g., the source location), the user can then complete a copy/cut and paste operation from only one location (e.g., the destination location), eliminating the need to be present at both the source and destination locations.

### SUMMARY

In accordance with the disclosed subject matter, systems and methods are described for providing pull and paste mechanisms.

Disclosed subject matter includes, in one aspect, a computerized method of pulling and pasting data among computing devices, which includes determining attributes of a first computing device, transmitting the attributes of the first computing device to a second computing device, receiving a pulling request for copying information from the first computing device to the second computing device, wherein the information resides on the first computing device, automatically processing the pulling request at the first computing device and automatically generating a response to the pulling request, and automatically sending the response to the pulling request back to the second computing device, wherein the response contains the information.

In some embodiments, the information is converted to a different form before the information is sent back to the second computing device.

In some other embodiments, the response to the pulling request contains a query, relating to the information, targeting the second computing device.

In some other embodiments, the information includes a location of the first computing device.

In some other embodiments, the information includes a file on the first computing device.

In some other embodiments, the information includes content stored in a clipboard of the first computing device.

Disclosed subject matter includes, in another aspect, a non-transitory computer readable medium having executable instructions that, when executed by a processor, cause the processor to determine attributes of a first computing device, transmit the attributes of the first computing device to a second computing device, receive a pulling request for copying information from the first computing device to the second computing device, wherein the information resides on the first computing device, automatically process the pulling request at the first computing device to generate a response to the pulling request, and automatically send the response to the pulling request back to the second computing device, wherein the response contains the information.

In some embodiments, the information is converted to a different form before the information is sent back to the second computing device.

In some other embodiments, the response to the pulling request contains a query, relating to the information, targeting the second computing device.

In some other embodiments, the information includes a location of the first computing device.

In some other embodiments, the information includes a file on the first computing device.

In some other embodiments, the information includes content stored in a clipboard of the first computing device.

Disclosed subject matter includes, in yet another aspect, a computerized method of pulling and pasting information among computing devices, which includes receiving attributes of a first computing device, at a second computing device, presenting pulling options, on the second computing device, based on the attributes of the first computing device, receiving a request from a user, based on the pulling options, for information stored in the first computing device, generating at the second computing device, based on the request from the user, a pulling request for copying information from the first computing device to the second computing device, wherein the information resides on the first computing device, sending the pulling request to the first computing device, receiving, at the second computing device, a response to the pulling request from the first computing device, wherein the response is automatically generated on the first computing device and wherein the response contains the information.

In some embodiments, the response to the pulling request from the first computing device contains a query relating to the information targeting the second computing device.

In some other embodiments, the information includes a location of the first computing device.

In some other embodiments, the information includes a file on the first computing device.

In some other embodiments, the information includes content stored in a clipboard of the first computing device.

Disclosed subject matter includes, in yet another aspect, a non-transitory computer readable medium having executable instructions that, when executed by a processor, cause the processor to: receive attributes of a first computing device, at a second computing device, present pulling options, on the second computing device, based on the attributes of the first computing device, receive a request from a user, based on the pulling options, for information stored in the first computing device, generate at the second computing device, based on the request from the user, a pulling request for copying information from the first computing device to the second computing device, wherein the information resides on the first computing device, send the pulling request to the first computing device, receive, at the second computing device, a response to the pulling request from the first computing device, wherein the response is automatically generated on the first computing device and wherein the response contains the information.

In some embodiments, the response to the pulling request from the first computing device contains a query, relating to the information, targeting the second computing device.

In some other embodiments, the information includes a location of the first computing device.

In some other embodiments, the information includes a file on the first computing device.

In some other embodiments, the information includes content stored in a clipboard of the first computing device.

Various embodiments of the subject matter disclosed herein can provide one or more of the following capabilities. A pull and paste system can provide more efficient and robust mechanisms of copying/cutting and pasting data among computing devices, especially among remote devices. A pull and paste system in some embodiments can reduce the manual steps required in conventional copy/cut and paste operations. According to embodiments of a pull and paste system, the copy/cut step of a pull and paste operation can occur automatically in the background; from a user's perspective, the copy/cut operation is eliminated and the user only needs to select then paste the desired data. When the source and destination devices of a pull and paste operation are remote to each other, the user of embodiments of a pull and paste system is no longer required to physically visit two separate devices. According to some embodiments, the pull and paste system can also provide context aware selection and copying.

These and other capabilities of embodiments of the invention will be more fully understood after a review of the following figures, detailed description, and claims.

### BRIEF DESCRIPTION OF THE DRAWINGS

FIG. 1 illustrates a diagram of an exemplary networked communication system.

FIG. 2A illustrates a block diagram of an exemplary pull and paste system.

FIG. 2B illustrates a block diagram of another exemplary pull and paste system.

FIG. 2C illustrates a block diagram of yet another exemplary pull and paste system.

FIG. 3 illustrates a block diagram of an exemplary pull and paste agent in a pull and paste system according to some embodiments of the disclosed subject matter.

FIG. 4 illustrates an exemplary pull and paste device (PPD) directory in a pull and paste system according to some embodiments of the disclosed subject matter.

FIG. 5A illustrates an exemplary pull and paste main UI menu according to some embodiments of the disclosed subject matter.

FIG. 5B illustrates an exemplary pull and paste follow-up UI menu according to some embodiments of the disclosed subject matter.

FIG. 5C illustrates another exemplary pull and paste main UI menu according to some embodiments of the disclosed subject matter.

FIG. 6 illustrates an exemplary operation according to some embodiments of the disclosed subject matter.

FIG. 7 illustrates a block diagram of an exemplary pull and paste device in a pull and paste system according to some embodiments of the disclosed subject matter.

### DETAILED DESCRIPTION

In this document, the “source” device refers to the computing device where the desired data object (e.g., text, image, file, etc.) is copied/cut from; the “destination” device refers to the computing device where the desired data object is pasted to.

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the embodiments described below are only examples, and that it is contemplated that there are other systems and methods that are within the scope of the disclosed subject matter.

Various embodiments of the subject matter disclosed herein can provide more efficient and robust mechanisms of copying/cutting and pasting data among computing devices, especially among remote devices. According to some embodiments, a pull and paste system can reduce the manual steps required in conventional 3-step selection-copy/cut-paste operations. For example, in a pull and paste operation, the copy/cut step can occur automatically in the background; from a user's perspective, the copy/cut step can be eliminated and the user only needs to select then paste the desired data. When the source and destination devices are remote and separate to each other, the user of embodiments of a pull and paste system is no longer required to physically visit two separate devices to copy data between the two devices.

In one exemplary embodiment, a pull and paste system can contain two pull and paste devices (i.e., one source device and one destination device) and can optionally contain a pull and paste server. The pull and paste server can manage the pull and paste system, such as controlling access and managing security. Additionally, the management function can also be provided by one or more of the devices internally. The source device and the destination device can each have a pull and paste agent running in the background. The pull and paste agent on the source device can determine the attributes of the source device and monitor any incoming pull and paste requests. The attributes of the source device can determine what information can be copied from the source device and how the information can be copied. For example, the attributes of the source device can indicate that screen captures are allowed on the source device and can also specify the screen capture resolution.

In one exemplary pull and paste operation, the destination device can first learn the attributes of the source device (either from the source device itself or from the optional pull and paste server) and can present options to the user of the destination device according to the attributes of the source device. For example, if screen capture is allowed but clipboard access is not, the option to capture screen can be enabled while the option to copy clipboard can be disabled among the options presented on the destination device. The user can then select on the destination device what information he/she desires to copy from the source device.

Next, the destination device can generate a pull and paste request based on the user's selection and send the request to the source device. When the source device receives the pull and paste request, the source device can process the request and automatically generate a response without any manual actions. For example, when a pull and paste request for screen capture arrives, the source device can capture its screen and automatically send the captured screenshot in a response to the destination device. Since the pull and paste request can inform the source device what information is to be pulled and how it is to be pulled, the pull and paste system in some embodiments can also provide context aware selection and copying. Once the response arrives at the destination device, the destination device can automatically process the data (e.g., show the screenshot in a default image viewer) or store the data in its own clipboard so that it is ready to be pasted on the destination device.

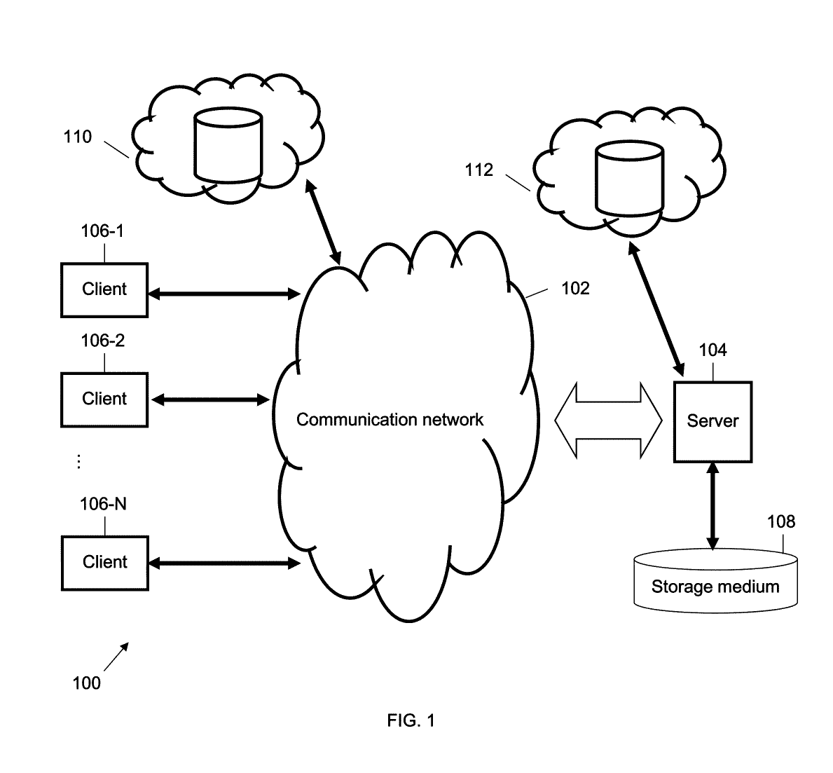

Embodiments of the disclosed subject matter can be implemented in a networked computing system. FIG. 1 illustrates a diagram of an exemplary networked communication arrangement 100 in accordance with some embodiments of the disclosed subject matter. The networked communication arrangement 100 can include a server 104, at least one client 106 (e.g., client 106-1, 106-2, . . . 106-N), a physical storage medium 108, and a cloud storage 110 and 112, which can all be coupled, directly or indirectly to a communication network 102.

Each client 106 can communicate with the server 104 to send data to, and receive data from, the server 104 across the communication network 102. Each client 106 can be directly coupled to the server 104; alternatively, each client 106 can be connected to server 104 via any other suitable device, communication network, or combination thereof. For example, each client 106 can be coupled to the server 104 via one or more routers, switches, access points, and/or communication network (as described below in connection with communication network 102). A client (e.g., 106-1) can also communicate with other client(s) (e.g., 106-2), either directly or indirectly. Two or more clients can interact with or without involvement of the server 104. A client (e.g., 106-1) can include, for example, a desktop computer, a mobile computer, a tablet computer, a cellular device, a smartphone, or any computing systems or devices that are capable of performing computation.

Server 104 can be coupled to at least one physical storage medium 108, which can be configured to store data for the server 104. Preferably, any client 106 can store data in, and access data from, the physical storage medium 108 via the server 104. FIG. 1 shows the server 104 and the physical storage medium 108 as separate components; however, the server 104 and physical storage medium 108 can be combined together. FIG. 1 also shows the server 104 as a single server; however, server 104 can include more than one server. FIG. 1 shows the physical storage medium 108 as a single physical storage medium; however, physical storage medium 108 can include more than one physical storage medium. The physical storage medium 108 can be located in the same physical location as the server 104, at a remote location, or any other suitable location or combination of locations.

FIG. 1 shows two embodiments of a cloud storage 110 and 112. Cloud storage 110 and/or 112 can store data from physical storage medium 108 with the same restrictions, security measures, authentication measures, policies, and other features associated with the physical storage medium 108. FIG. 1 shows the cloud storage 112 separate from the communication network 102; however, cloud storage 112 can be part of communication network 102 or another communication network. The server 104 can use cloud storage 110 only, cloud storage 112 only, or both cloud storages 110 and 112. While FIG. 1 shows one cloud storage 110 and one cloud storage 112, more than one cloud storage 110 and/or more than one cloud storage 112 or any suitable combination thereof can be used.

The communication network 102 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks can be implemented with any number of hardware and software components, transmission media and network protocols. FIG. 1 shows the network 102 as a single network; however, the network 102 can include multiple interconnected networks listed above.

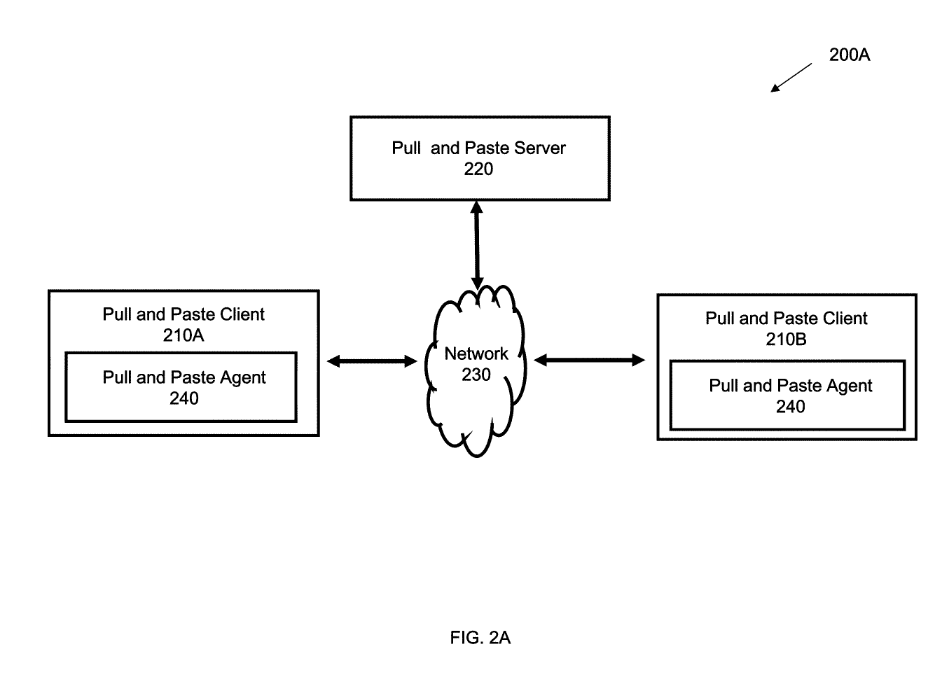

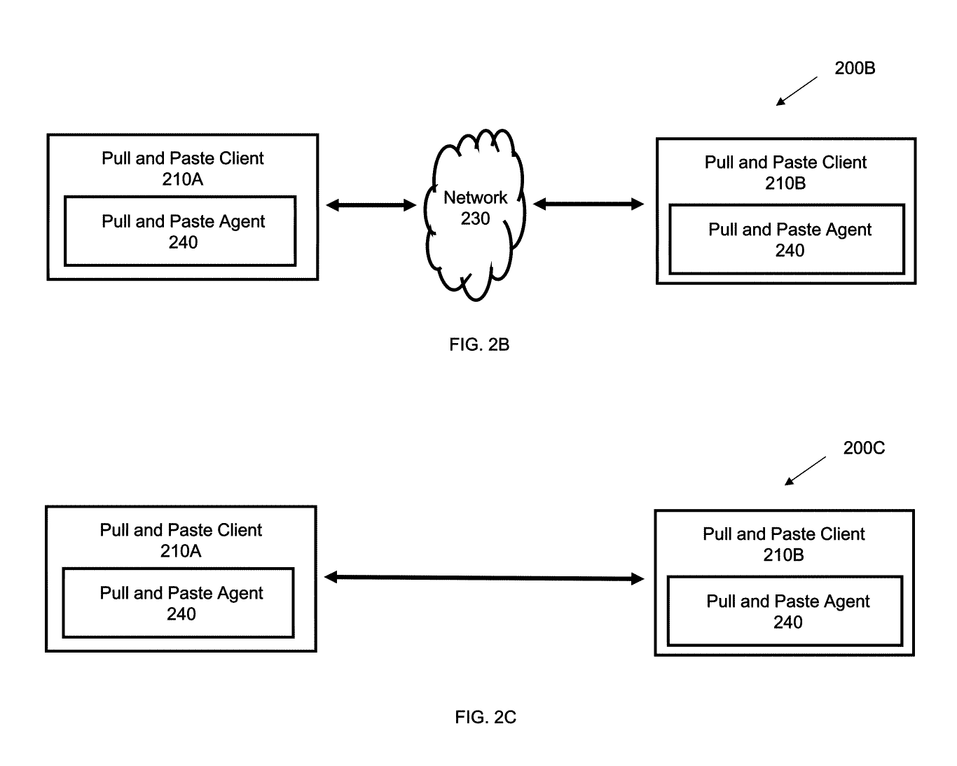

FIG. 2A illustrates a block diagram of an exemplary pull and paste system 200A in accordance with certain embodiments of the disclosed subject matter. The pull and paste system 200A can include one or more pull and paste clients 210A and 210B and a pull and paste server 220 that are coupled to a network 230. The pull and paste clients 210A and 210B and the pull and paste server 220 can be directly or indirectly coupled to the network 230 and can communicate among each other via the network 230, which can be wired, wireless, or a combination of both. The pull and paste clients 210A and 210B can directly or indirectly communicate with each other to operate as the source and destination devices with or without involving a pull and paste server.

The pull and paste clients 210A, 210B, like each client 106 illustrated in FIG. 1, can include a desktop computer, a mobile computer, a tablet computer, a cellular device, a smartphone, or any computing systems or devices that are capable of performing computation. The pull and paste server 220 can also include a desktop computer, a mobile computer, a tablet computer, a cellular device, a smartphone, or any computing systems or devices that are capable of performing computation. Although FIG. 2A shows the pull and paste server 220 as a single server, the pull and paste server 220 can include more than one physical and/or logical servers. The network 230, like the communication network 102 illustrated in FIG. 1, can include the Internet, a cellular network, a telephone network, a computer network, a packet switching network, a line switching network, a local area network (LAN), a wide area network (WAN), a global area network, a corporate network, an intranet, a virtual network, or any number of private networks currently referred to as an Intranet, and/or any other network or combination of networks that can accommodate data communication. Such networks can be implemented with any number of hardware and software components, transmission media and network protocols. FIG. 2A shows the network 230 as a single network; however, the network 230 can include multiple interconnected networks listed above.

FIG. 2B illustrates a block diagram of another exemplary pull and paste system 200B in accordance with certain embodiments of the disclosed subject matter. The pull and paste system 200B can include one or more pull and paste clients 210A and 210B coupled to a network 230. The pull and paste clients 210A and 210B can be directly or indirectly coupled to the network 230 and communicate among each other via the network 230, which can be wired, wireless, or a combination of both. Unlike the embodiments illustrated in FIG. 2A, the pull and paste system 200B can operate without a central pull and paste server. The pull and paste clients 210A and 210B can communicate with each other to operate as the source and destination devices without a pull and paste server.

FIG. 2C illustrates a block diagram of yet another exemplary pull and paste system 200C in accordance with certain embodiments of the disclosed subject matter. The pull and paste system 200C can include one or more pull and paste clients 210A and 210B. The pull and paste clients 210A and 210B can be directly coupled to each other. Unlike the embodiments illustrated in FIGS. 2A and 2B, the pull and paste system 200C can operate without an external network. The pull and paste clients 210A and 210B can communicate with each other directly to operate as the source and destination devices without an external network. For example, the pull and paste clients 210A and 210B can communicate with each other via a point-to-point connection such as a hardwired network connection (e.g., Ethernet), a wireless connection (e.g., 802.11), Bluetooth, infrared, etc.

Referring to FIGS. 2A, 2B, and 2C, each pull and paste client 210A or 210B can include a pull and paste agent 240. The pull and paste agent 240 can be embedded inside the pull and paste client 210A or 210B as a software module, a hardware component, or a combination of both. Alternatively, the pull and paste agent 240 can also be separate from but coupled to the pull and paste client 210A or 210B. The pull and paste client 210A or 210B can communicate with the pull and paste server 220 (to the extent one is used) directly or via its agent 240. The pull and paste clients can communicate among each other directly or via their agents 240.

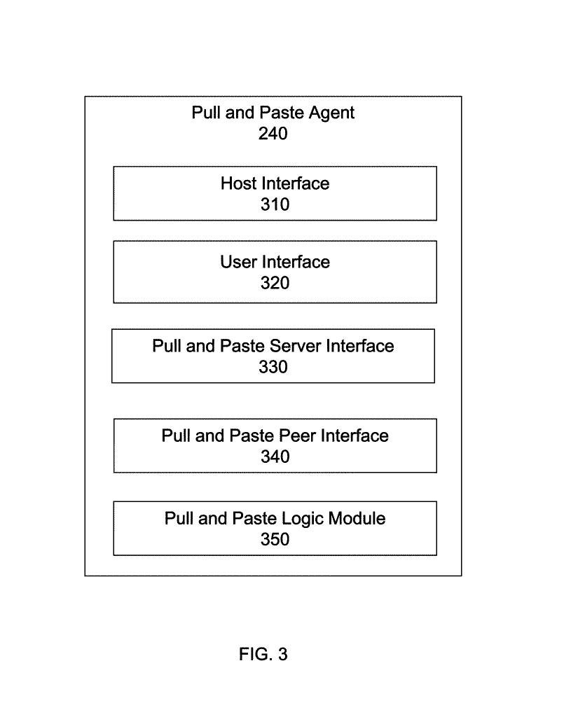

FIG. 3 illustrates a block diagram of an exemplary pull and paste agent 240 in a pull and paste system. A pull and paste agent 240 can include a host interface 310, a user interface 320, a pull and paste server interface 330, a pull and paste peer interface 340, and a pull and paste logic module 350. The pull and paste agent 240 can communicate with its associated host (e.g., a pull and paste client 210A or 210B) through the host interface 310. The pull and paste agent 240 can interact with the users through the user interface 320. The pull and paste agent 240 can communicate with the pull and paste server 220 through the pull and paste server interface 330. The pull and paste agent 240 can also communicate with one or more other pull and paste clients through the pull and paste peer interface 340. The pull and paste logic module 350 can provide application logic and execution of pull and paste requests on the pull and paste client 210A or 210B.

In one example, the pull and paste logic module 350 can retrieve and/or configure the host client's status (e.g., online or offline). In another example, the pull and paste logic module 350 can get and/or set the group affiliation information of the host client 210A/210B. In yet another example, the pull and paste logic module 350 can access and/or customize the policy information (e.g., access rights, security restrictions, etc.) of the host client 210A/210B and/or the pull and paste system. In yet another example, the pull and paste logic module 350 can get and/or set configurations of the host client 210A/210B and/or the pull and paste system. Detailed descriptions of status, group affiliation, policy, and configurations of pull and paste clients and systems are discussed in later sections. A pull and paste agent can have some or all the components discussed above. The pull and paste agent 240 is exemplary only and not limiting. For example, a pull and paste agent can have a pull and paste server interface 330 without a pull and paste peer interface 340, can have a pull and paste peer interface 340 without a pull and paste server interface 330, or can have both a pull and paste server interface 330 and a the pull and paste peer interface 340.

A pull and paste system (e.g., the pull and paste system 200A in FIG. 2A) can be managed by a pull and paste server 220. A pull and paste server 220 can store and maintain a pull and paste device (PPD) directory. A PPD directory can keep track of the pull and paste devices within a pull and paste system and their attributes. A PPD directory can help the pull and paste server 220 manage a pull and paste system.

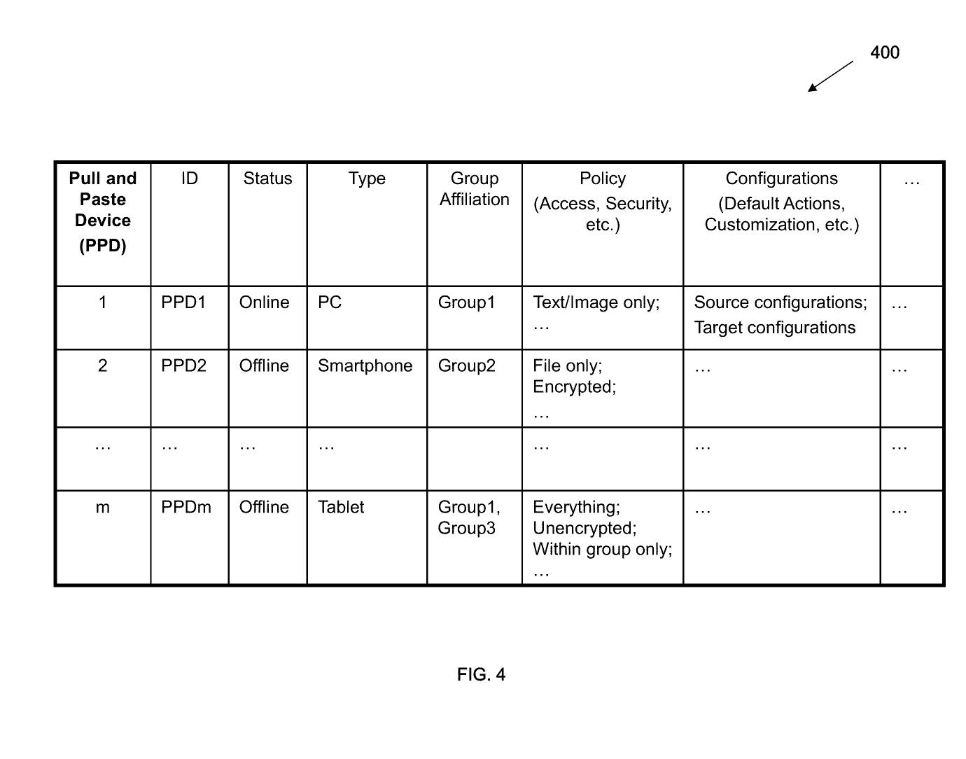

FIG. 4 illustrates an exemplary PPD directory 400 in a pull and paste system. The PPD directory 400 can be used for maintaining information about the pull and paste devices within the pull and paste system. The PPD directory 400 can contain the relevant information about each of the pull and paste device (e.g., device 1 through m) in the pull and paste system. The PPD directory 400 can be updated manually or automatically when a pull and paste device is added/removed/modified. For each pull and paste device (e.g., device 1-m), the PPD directory 400 can include information, such as device ID, status, type, group affiliation, policy, and configuration, etc. The PPD directory 400 can be used to, for example enforce policies associated with one or more of the pull and paste devices.

The device ID (e.g., PPD1-m) of a pull and paste device can be used to uniquely identify a pull and paste device. The device ID can be assigned by the pull and paste device or its user. The device ID can also be a randomly generated identifier that uniquely identifies a pull and paste device in the pull and paste system. In some embodiments, the device ID can be derived from existing information to identify a pull and paste device. For example, the device ID can be in the form of an IP address or MSISDN of the pull and paste device. Other forms of device IDs can also be used in the PPD directory.

The status column in the PPD directory 400 can contain information about the current status of each pull and paste device. For example, the status can indicate whether a pull and paste device is online or offline. A pull and paste device can automatically advertise its online status when its online status changes. In some embodiments, a pull and paste device can be considered offline if no update has been received from the pull and paste device for a certain period of time. Alternatively, a pull and paste device or its user can set its online status manually. For example, a user who prefers not to receive a pulling request can choose to manually set its pull and paste device to offline. Other types of device status information can also be included in the PPD directory.

The type column in the PPD directory 400 can contain information indicating what type of device each pull and paste device is. For example, the type information can indicate whether a pull and paste device is a PC, a Mac, a tablet, a smartphone, or other type of computing devices. The type information of a pull and paste device can be automatically determined (e.g., by a pull and paste agent 240) and updated. Additionally, a pull and paste device or its user can override the automatically determined type information and set the type information manually. In some embodiments, the type of a pull and paste device can affect its policy and/or configurations (e.g., what information can be pulled from the source device, how pulled information can be processed on the destination device, etc.). For example, if a pull and paste device is a smartphone, its phone number or call history can be pulled. Other kinds of device type information can also be included in the PPD directory.

The group affiliation column in the PPD directory 400 can contain information about whether/how a pull and paste device belongs to certain groups. A pull and paste system can be configured to contain groups. The groups can be configured based on various information (e.g., physical or logical location, device type, configurations, policy, etc.) The pull and paste devices in a pull and paste system can optionally be categorized into one or more groups. The pull and paste devices within a group can share the same configurations or policy. In some embodiments, the group affiliation of a pull and paste device can be configured centrally by a system administrator of the pull and paste system. In some other embodiments, the group affiliation of a pull and paste device can be customizable and set by individual pull and paste devices. Other types of group affiliation information can also be included in the PPD directory.

The policy column in the PPD directory 400 can contain information about the policy information of each pull and paste device. In some embodiments, the policy of a pull and paste device can be universally configured and centrally controlled by a system administrator of a pull and paste system. In some other embodiments, the policy of each pull and paste device can be individually configured and controlled. In some other embodiments, the policy of a pull and paste device can be based on a default policy and customizable by the pull and paste device. The policy information can include access information. For example, a policy can define that only texts or screenshots can be accessed (e.g., pulled) from a pull and paste device; a different policy can define that only existing files (but not text in the clipboard or screenshots) can be accessed (e.g., pulled) from a pull and paste device; another policy can allow access to everything on a pull and paste device; and yet another policy can allow or disallow modification (e.g., editing or deletion) to data on a pull and paste device. The policy information can also include security requirement information. For example, a policy can require that data pulled from a pull and paste device be encrypted before transmission, while a different policy may allow unencrypted transmission. The policy information can also relate to the group affiliation information of the pull and paste devices and/or the pull and paste system. For example, a policy can prohibit a pull and paste device from being accessed by pull and paste devices outside the same group or in a different group. Other type of client policy information can also be included in the PPD directory. For example, a policy of a pull and paste device can define whether its location information can be accessed by other pull and paste devices.

The configuration column in the PPD directory 400 can contain information about how each pull and paste device is configured. In some embodiments, the configuration of a pull and paste device can be universally set and centrally controlled by a system administrator of a pull and paste system. In some other embodiments, the configuration of each pull and paste device can be individually set and controlled. In some other embodiments, the configuration of a pull and paste device can be based on a default configuration and customizable by the pull and paste device.

The configuration information can include how a pull and paste device is configured as a source device of pull and paste operations. In some embodiments, the configuration can define how data (e.g., file, text, contacts, etc.) can or should be pulled when a pulling request arrives at a source device. For example, the configuration information can set limitations based on size (e.g., smaller than 100 MB) or attributes (e.g., image file only, from a certain directory only, etc.) when files are pulled from a pull and paste device; the configuration information can define the capture resolution when a screenshot is pulled; the configuration information can limit the number of entries when web links are pulled (e.g., the five most recently accessed URLs, all URLs accessed today, etc.); the configuration information can define how texts are pulled (e.g., with or without formatting, from the clipboard, from the foreground window, etc.); the configuration information can define what location information is available (e.g., city/town and state information, longitude and latitude coordinates, etc.) when the location is pulled; the configuration information can also define what information is available (e.g., CPU, memory, storage capacity, device type, network connection and bandwidth) when system information is pulled; the configuration information can also indicate that when contacts are pulled from a pull and paste device (e.g., a smartphone) what contact information (e.g., name, phone number(s), or address(es), etc.) are copied. In some other embodiments, the configuration can also define how to resolve an ambiguity. For example, when a screen capture pulling request is received, the pull and paste device can be configured to capture the active foreground window only, the entire screen, or multiple screens, etc. The pull and paste device can be configured to make decisions automatically or to prompt for further instructions/confirmations.

The configuration information can also include how a pull and paste device is configured as the destination device of pull and paste operations. In some embodiments, the configuration can define how data (e.g., file, text, contacts, etc.) pulled from a source device can or should be handled when it arrives at a destination device. For example, the configuration information can define how to handle a pulled file when it arrives at the destination device (e.g., put the file in the clipboard, copy the file into a temporary directory location, scan for security threats, or automatically open the file, etc.); the configuration information can also define how to process a pulled screen capture (e.g., put the image in the clipboard, display the image automatically, etc.); the configuration information can also define how to process pulled web link(s) (e.g., display the list of URL(s), launch the default Internet browser using some or all pulled URLs, etc.); the configuration information can also define how to process pulled text (e.g., put the text into the clipboard of the destination device, launch the default text editor embedded with the pulled text, etc.); the configuration information can also define how to process a pulled location (e.g., display the location, launch a mapping application on the destination device using the pulled location, etc.). In some other embodiments, the configuration can also define how to interact with a user in certain situations when further input is needed/desired (e.g., to resolve an ambiguity). For example, when multiple files are available to be pulled from a source device, a pull and paste device can configured to prompt the user with a list of available files and ask the user to select which one(s) to be pulled.

Optionally, the configuration information can include both how a pull and paste device is configured both as a source device and as a destination device of pull and paste operations. Other type of client configuration information can also be included in the PPD directory.

A PPD directory can have some or all the information discussed above. That is, just because the PPD directory 400 includes a column for certain types of information does not necessarily mean that each pull and paste device has the corresponding information associated with it (e.g., the PPD directory can include blank cells/entries). The PPD directory 400 is exemplary only and not limiting. For example, additional types of information can also be included for each pull and paste device in the PPD directory 400.

Two pull and paste devices can directly or indirectly communicate with each other to operate as the source and destination devices of pull and paste operations. The two pull and paste devices can operate within a network coupled with a central pull and paste server. Alternatively, the two pull and paste devices can operate within a network without a central pull and paste server. Data structures containing information similar to what's stored in a PPD directory 400 can be stored and maintained in a distributed manner among pull and paste devices. One example of such networks is a peer-to-peer network. In some situations, two pull and paste devices can operate on a point-to-point connection and without an external network. In these situations, two pull and paste devices can exchange their attributes (e.g., status, type, group affiliation, policy, configurations, etc.) during a handshake process when connection between them is established.

Generally, a pulling request can be generated on the destination device then sent to the source device, which can process the pulling request and return the pulled data back to the destination device (e.g., to be pasted). When two pull and paste devices (i.e., a source device and a destination device) establish communication, either directly or indirectly, with or without a pull and paste server, attributes (e.g., status, type, group affiliation, policy, configurations, etc.) of the two pull and paste devices can be exchanged. The exchange of attributes can be two-way or one-way. During the exchange, one pull and paste device (e.g., the destination device) can learn what and how information can be pulled from the other pull and paste device (e.g., as a source device). A user of a pull and paste device (as the destination device) can initiate a pulling request through a user interface, which can be presented by a pull and paste agent on the destination device.

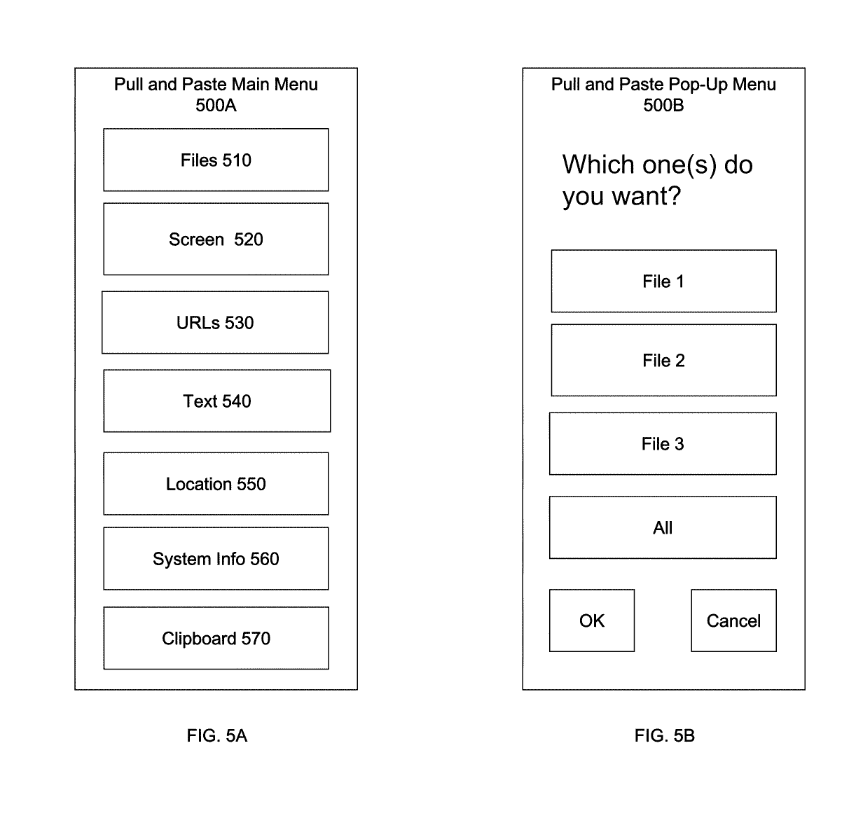

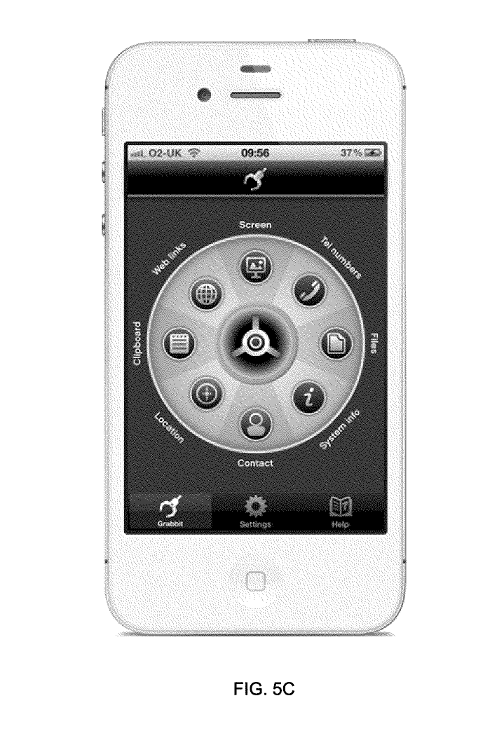

FIG. 5A demonstrates one example of pull and paste user interfaces. As illustrated in FIG. 5A, an exemplary pull and paste main menu 500A can present a user with options about what to be pulled from a source device. In this example, the user can select Files 510 to copy one or more files from another pull and paste device (i.e., the source device), select Screen 520 to capture screen(s) of the source device, select URLs 530 to copy web links accessed on the source device, select Text 540 to copy the text displayed on the source device, select Location 550 to request the location of the source device, select System Info 560 to learn the system information of the source device, or select Clipboard 570 to get a copy of data stored in the clipboard of the source device. In some embodiments, the available options presented to the user on the destination device can be determined by the source device's attributes (e.g., status, type, group affiliation, policy, configurations, etc.). For example, if screen capture is not allowed on the source device (e.g., by the administrator of the pull and paste system, or by the user of the source device), the Screen 520 option may be disabled or hidden in the pull and paste main menu 500A. In another example, if the policy on the source device prohibits disclosure of its location, the Location 550 option may be disabled or hidden in the pull and paste main menu 500A. In some other embodiments, the available options presented to the user on the destination device (e.g., via the pull and paste main menu 500A) can be configured or customized on the destination device, either by a pull and paste server or by the individual pull and paste device.

FIG. 5B demonstrates another example of pull and paste user interfaces. The exemplary pull and paste pop-up menu 500B illustrated in FIG. 5B can be presented to the user when further information is needed or desired. For example, when a user initiates a pulling request to copy files from a source device but there are multiple files available on the source device, the source device can respond with a list of available files to the destination device. The destination device can then process the response and present the list of available files (e.g., as illustrated in FIG. 5B) to the user on the destination device. Once the user makes his/her selection(s), the information can be communicated to the source device so that the pulling request can be fulfilled.

FIG. 5C contains a screenshot of another exemplary pull and paste main menu according to some embodiments of the disclosed subject matter. As illustrated in this example, when the source device is a smartphone, telephone numbers and other contact information can be pulled from the source device. Similar to the pull and paste user interface illustrated in FIG. 5A, the available options presented to the user on the destination device can be determined by the source device's attributes (e.g., status, type, group affiliation, policy, configurations, etc.) and can also be configured or customized on the destination device, either by a pull and paste server or by the individual pull and paste device. This interface is more fully described in co-pending U.S. application Ser. No. ______ [Docket #: 2207391.00156-US1], which is incorporated by reference herein in its entirety.

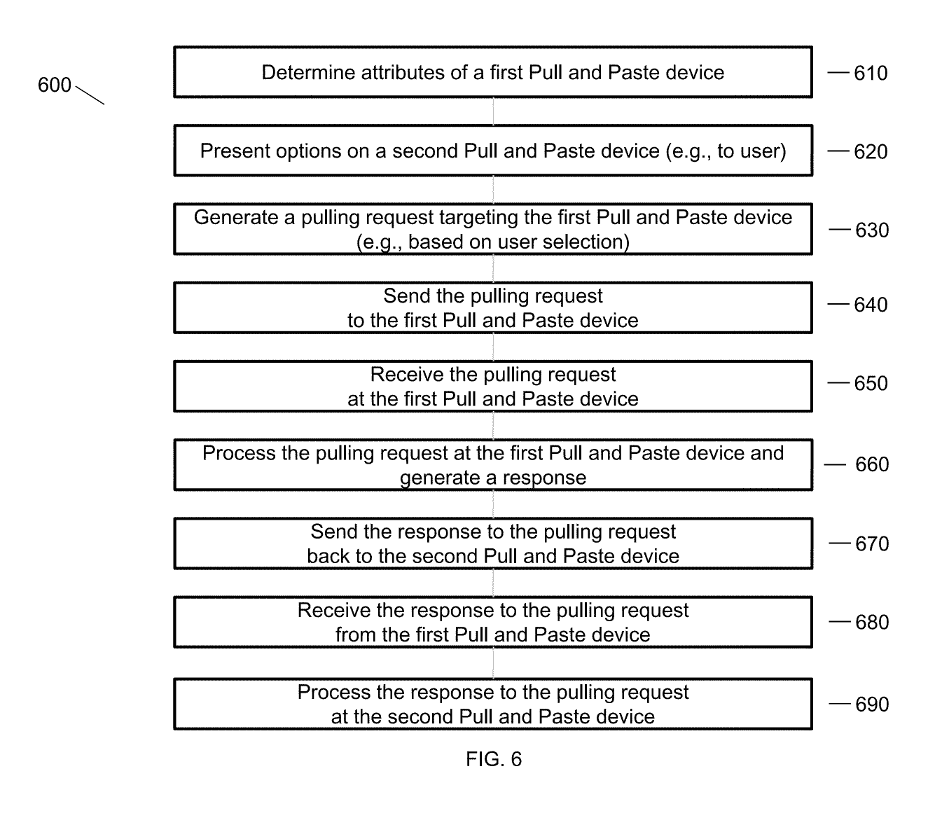

When two pull and paste devices (one as a source device and the other as a destination device) are coupled, either directly or indirectly, either with or without a pull and paste server, a pull and paste operation can be executed between the source device and the destination device. FIG. 6 illustrates an exemplary pull and paste operation 600. The operation 600 can be modified by, for example, having stages rearranged, changed, added and/or removed.

At stage 610, attributes of a first pull and paste device (as the source device) can be determined. The attributes can include information such as the status, type, group affiliation, policy, and configurations, etc. The source device's attributes may be determined (e.g., using the PPD directory 400) by the pull and paste agent on the source device and may be stored and maintained on a pull and paste server. Alternatively, the source device's attributes may be determined on demand when a second pull and paste device (as the destination device) is coupled with the first pull and paste device (as the source device). The second pull and paste device (the destination device) may receive the attributes of the first pull and paste device (the source device) during a handshake process when communication is established between the two devices.

At stage 620, options can be presented on the second pull and paste device (the destination device). The pull and paste agent on the destination device can determine the available/desired options based on the attributes of the source device. The options can be presented to the user of the destination device so that the user can select what information to be pulled from the source device.

At stage 630, a pulling request targeting the first pull and paste device (the source device) can be generated on the second pull and paste device (the destination device). The pulling request can be generated in response to a user's selection or generated automatically by the destination device itself. The pulling request can describe the information being requested in various formats. In one embodiment, the pulling request can specify the information being requested in a Representational State Transfer (REST) hierarchical format, e.g., “/client/resource/ . . . ” For example, “richsMac/display/1/screen” can indicate that the screenshot on the first display of Rich's Mac machine is being requested; “richsWinPC/application/31245/screen” can indicate that a screenshot of Application 31245's UI window on Rich's Windows PC is being requested. Similarly formatted requests can be used to request for other types of information, such as files, clipboards, etc. In another embodiment, the pulling request can specify the information being requested in a Universal Resource Locator (URL) format. One example of such a request can include:
. . . command:ggrabit?grab=<command>&target=<targetId>&item=<itemId>,
wherein “command” can indicate the object type, e.g., file, screen, clipboard, etc.; “targetId” can identify the target device, e.g., a computer name, IP address, MAC address, etc.; “itemId” can define the specific item being requested, e.g., a file name or index number in a list of files.
   Some of the fields (e.g., “itemId”) can be optional. For example, when a screenshot is requested from a device, the “itemId” field may be omitted or left blank.

At stage 640, the generated pulling request is sent to the first pull and paste device (the source device). The pulling request can be sent via a pull and paste server over a network, sent over a network without a pull and paste server, or sent directly to the source device without going through a network.

At stage 650, the pulling request can be received at the first pull and paste device (the source device). The pulling request can be received via a pull and paste server over a network, received over a network without a pull and paste server, or received directly from the destination device without going through a network. The pull and paste agent on the first pull and paste device (the source device) can continuously monitor any incoming pulling requests originated from other pull and paste devices.

At stage 660, the pulling request can be processed at the first pull and paste device (the source device). The pull and paste agent on the first pull and paste device (the source device) can help process the pulling request and generate a response to the pulling request. The response can be generated automatically without any user input or manual action. What information should be pulled and how the information should be pulled can be determined by the pulling request and can also be affected by the attributes of the source device (e.g., its policy and configurations). For example, if a pulling request for files is received, the source device can access a default or pre-determined file directory and copy/cut the file(s) within the directory.

The file directory or directories can be determined by the source device's attributes or be specified in the pulling request itself. If a pulling request for screen is received, the source device can capture screenshot(s). Whether the screen capture should be for the desktop, for multiple windows, or limited to the active window can be determined by the policy and configurations of the source device and can also be specified in the pulling request itself. If a pulling request for URLs is received, the source device can access the Internet browsing history and get a copy of recently websites visited. The number of URLs copied or other limitations (e.g., time duration) can be determined by the attributes of the source device and/or specified in the pulling request itself. If a pulling request for location is received, the source device can determine its current location (e.g., via a GPS module or other location-determination mechanisms). The format or nature of the location (e.g., longitude/latitude, city/town and state, physical or logical location, etc.) can be determined by the attributes of the source device and can also be defined in the pulling request. If a pulling request for clipboard is received, the source device can obtain a copy of what's stored in the clipboard on the source device. Since the pulling request can inform the source device what information is to be pulled and how it is to be pulled, the pull and paste system in its embodiments can also provide context aware selection and copying.

The first pull and paste device (the source device) can transform the data being pulled (e.g., text, image, location, etc.) before the data is sent back to the second pull and paste device (the destination device). For example, if an image is being pulled from the first pull and paste device but the resolution of the image is too high for transmission, the first pull and paste device can downgrade the image to a lower resolution before sending the image file back to the second pull and paste device. In another example, if a video file is being pulled from the first pull and paste device but the format of the video file is incompatible with the second pull and paste device, the first pull and paste device, a pull and paste server, or another computing device can convert the video file into a different format before sending the video file to the second pull and paste device. Additionally, the second pull and paste device (the destination device) can also transform the pulled data (e.g., text, image, location, etc.) after the data arrives at the second pull and paste device (the destination device).

At stage 670, the response to the pulling request can be sent back to the second pull and paste device (the destination device). The response can be sent back to the second pull and paste device automatically without any user input or manual action. The response can be sent via a pull and paste server over a network, sent over a network without a pull and paste server, or sent directly to the source device without going through a network. The response can be encoded or encrypted based on the policy and configurations of the source device or the pulling request itself. In some embodiments, if the pulling request is fully processed at stage 660, a complete response can be generated and sent back to the destination device. For example, when a pulling request for clipboard is received and processed on the source device, a copy of the data stored in the clipboard of the source device can be sent back to the destination device as the response. In some other embodiments, if the pulling request is not fully processed at stage 660 (e.g., due to some ambiguities), a query for clarification or confirmation can be generated and sent back to the destination device as the initial response. For example, when a pulling request for files is received at the source device but there are multiple files available to be pulled, a query for what file(s) to be pulled can be sent back to the destination device. The user on the destination device can then select which file(s) to be pulled, e.g., as illustrated in FIG. 5C.

At stage 680, the response to the pulling request can be received at the second pull and paste device (the destination device). The response to the pulling request can be received via a pull and paste server over a network, received over a network without a pull and paste server, or received directly from the source device without going through a network. The response to the pulling request can be in various formats, such as Extensible Markup Language (XML), JavaScript Object Notation (JSON), or binary (standard or customized), etc. In some embodiments, the response can be JSON formatted. In one example, a response in the JSON format can contain information such as a timestamp, a name, a source (e.g., “/Machine/App/ . . . ”), a location, etc. In another example, a JSON formatted response can contain a “Type” field to indicate the type of the pulling request and an “Entries” field containing an array of entries. Each entry can include a “Source” field, a “Title” field, a “Value” field, and a “isContainer” field. The “Source” field can indicate the name of the program where the data is copied from (e.g., Internet Explorer, Safari, or Chrome). The “Source” field can be empty if a file is being copied. The “Title” field can include a short name for display (e.g., a file name). The “Value” filed can contain the full name of the data being copied (e.g., a full file path, a URL, etc.). The “isContainer” field can include a Boolean value indicating if the requested target is a folder instead of a file. In another embodiment, the request can simply contain the actual data being copied (e.g., a JPEG image of screen, a file being requested, etc.).

At stage 690, the response to the pulling request can be processed at the second pull and paste device (the destination device). The pull and paste agent on the second pull and paste device (the destination device) can help process the response of the pulling request. How the response should be processed can be determined by the pulling request and/or the response itself and can also be affected by the attributes of the destination device (e.g., policy and configurations). For example, if a file is received in response to a pulling request for files, the destination device can put the received file into a temporary location or open the received file automatically, depending on the attributes (e.g., configurations) of the destination device. If a list of weblinks are received in response to a pulling request for URLs, the destination device can display the list on the destination device or launch a web browser using the weblink(s), depending on the attributes (e.g., configurations) of the destination device. If a copy of clipboard data is received in response to a pulling request for clipboard, the destination device can put the data into its own clipboard so that it is ready to be pasted onto other locations (e.g., on the destination device). Additionally, the user of the destination device can set up custom actions and/or policies describing how to process the response.

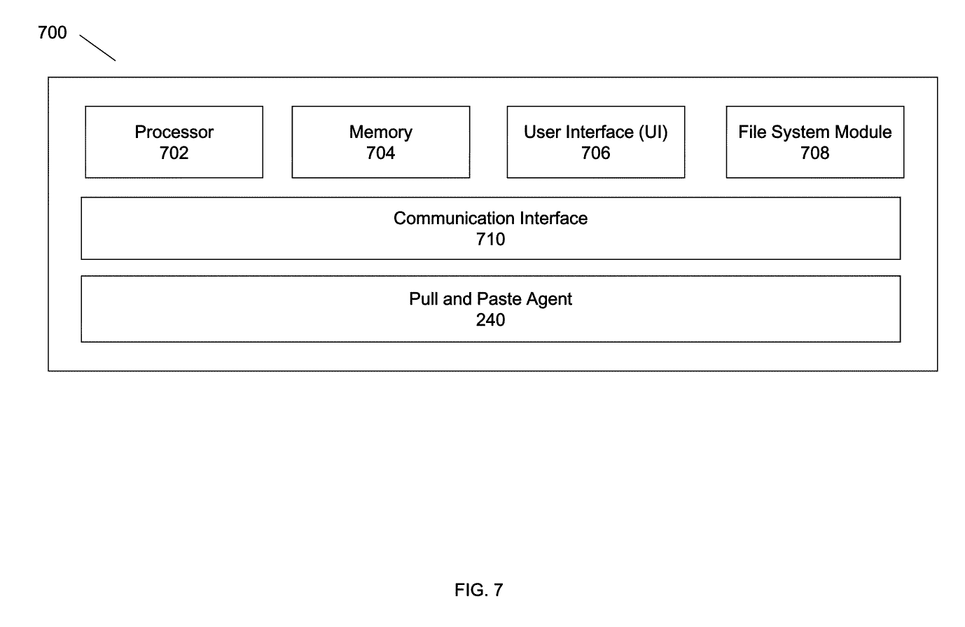

FIG. 7 illustrates a block diagram of a computing system that can be used to implement one or more aspects of the functionality described herein. The computing system 700 can serve as, for example, a client 106, a server 104, or both in the networked communication arrangement 100. The computing system 700 can also serve as, for example, a pull and paste device 210A or 210B, a pull and paste server 220, or any combinations of them in a pull and paste system. The computing system 700 can include at least one processor 702 and at least one memory 704. The processor 702 can be hardware that is configured to execute computer readable instructions such as software. The processor 702 can be a general processor or be an application specific hardware (e.g., an application specific integrated circuit (ASIC), programmable logic array (PLA), field programmable gate array (FPGA), or any other integrated circuit). The processor 702 can execute computer instructions or computer code to perform desired tasks. The memory 704 can include volatile and/or non-volatile computer readable medium, such as flash memory, a magnetic disk drive, an optical drive, a programmable read-only memory (PROM), a read-only memory (ROM), a random access memory (RAM), or any other memory or combination of memories.

The computing system 700 can also optionally include a user interface (UI) 706, a file system module 708, and a communication interface 710. The UI 706 can provide an interface for users to interact with the computing system 700 in order to access a pull and paste system. The file system module 708 can be configured to maintain a list of all data files, including both local data files and remote data files, in every folder in a file system. The file system module 708 can be further configured to coordinate with the memory 704 to store and cache files/data. The communication interface 710 can allow the computing system 700 to communicate with external resources (e.g., a network or a remote client/server). The computing system 700 can also include a pull and paste agent 240. The description of the pull and paste agent 240 and its functionalities can be found in the discussion relating to FIGS. 2-6. The computer system 700 can include additional modules, fewer modules, or any other suitable combination of modules that perform any suitable operation or combination of operations.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

A “server,” “client,” “agent,” “module,” “interface,” and “host” is not software per se and includes at least some tangible hardware that is configured to execute computer readable instructions. Additionally, the term “based on” is open ended and is not intended to be limiting. For example, if A is “based on” B, then A is a function of B, and potentially C, D, and E.

What is claimed is:

1. A computerized method of pulling and pasting data among computing devices, the method comprising:
determining attributes of a first computing device;
transmitting the attributes of the first computing device to a second computing device;
receiving a pulling request for copying information from the first computing device to the second computing device, wherein the information resides on the first computing device;
automatically processing the pulling request at the first computing device and automatically generating a response to the pulling request; and
automatically sending the response to the pulling request back to the second computing device, wherein the response contains the information.

2. The computerized method of claim 1, wherein the information is converted to a different form before the information is sent back to the second computing device.

3. The computerized method of claim 1, wherein the response to the pulling request contains a query, relating to the information, targeting the second computing device.

4. The computerized method of claim 1, wherein the information includes a location of the first computing device.

5. The computerized method of claim 1, wherein the information includes a file on the first computing device.

6. The computerized method of claim 1, wherein the information includes content stored in a clipboard of the first computing device.

7. A non-transitory computer readable medium having executable instructions that, when executed by a processor, cause the processor to:
determine attributes of a first computing device;
transmit the attributes of the first computing device to a second computing device;
receive a pulling request for copying information from the first computing device to the second computing device, wherein the information resides on the first computing device;
automatically process the pulling request at the first computing device to generate a response to the pulling request; and
automatically send the response to the pulling request back to the second computing device, wherein the response contains the information.

8. The non-transitory computer readable medium of claim 7, wherein the information is converted to a different form before the information is sent back to the second computing device.

9. The non-transitory computer readable medium of claim 7, wherein the response to the pulling request contains a query, relating to the information, targeting the second computing device.

10. The non-transitory computer readable medium of claim 7, wherein the information includes a location of the first computing device.

11. The non-transitory computer readable medium of claim 7, wherein the information includes a file on the first computing device.

12. The non-transitory computer readable medium of claim 7, wherein the information includes content stored in a clipboard of the first computing device.

13. A computerized method of pulling and pasting information among computing devices, the method comprising:
receiving attributes of a first computing device, at a second computing device;
presenting pulling options, on the second computing device, based on the attributes of the first computing device;
receiving a request from a user, based on the pulling options, for information stored in the first computing device;
generating at the second computing device, based on the request from the user, a pulling request for copying information from the first computing device to the second computing device, wherein the information resides on the first computing device;
sending the pulling request to the first computing device;
receiving, at the second computing device, a response to the pulling request from the first computing device, wherein the response is automatically generated on the first computing device and wherein the response contains the information.

14. The non-transitory computer readable medium of claim 13, wherein the response to the pulling request from the first computing device contains a query relating to the information targeting the second computing device.

15. The non-transitory computer readable medium of claim 13, wherein the information includes a location of the first computing device.

16. The non-transitory computer readable medium of claim 13, wherein the information includes a file on the first computing device.

17. The non-transitory computer readable medium of claim 13, wherein the information includes content stored in a clipboard of the first computing device.

18. A non-transitory computer readable medium having executable instructions that, when executed by a processor, cause the processor to:
receive attributes of a first computing device, at a second computing device;
present pulling options, on the second computing device, based on the attributes of the first computing device;
receive a request from a user, based on the pulling options, for information stored in the first computing device;
generate at the second computing device, based on the request from the user, a pulling request for copying information from the first computing device to the second computing device, wherein the information resides on the first computing device;
send the pulling request to the first computing device;
receive, at the second computing device, a response to the pulling request from the first computing device, wherein the response is automatically generated on the first computing device and wherein the response contains the information.

19. The non-transitory computer readable medium of claim 18, wherein the response to the pulling request from the first computing device contains a query, relating to the information, targeting the second computing device.

20. The non-transitory computer readable medium of claim 18, wherein the information includes a location of the first computing device.

21. The non-transitory computer readable medium of claim 18, wherein the information includes a file on the first computing device.

22. The non-transitory computer readable medium of claim 18, wherein the information includes content stored in a clipboard of the first computing device.
